(19) United States
(12) Patent Application Publication
(10) Pub. No.: US 2004/0174111 A1
(43) Pub. Date: Sep. 9, 2004

(54) Side projection type cathode ray tube

(76) Inventors: Sung Bee Choi, Kyungki-do (KR); Kyoung Mun Choo, Kyungki-do (KR)

Correspondence Address: BACON & THOMAS, PLLC, 625 SLATERS LANE, FOURTH FLOOR, ALEXANDRIA, VA, 22314

(21) Appl. No.: 10/480,644

(22) PCT Filed: Jun. 29, 2002
(86) PCT No.: PCT/KR02/01246

(30) Foreign Application Priority Data
Jun. 29, 2001 (KR) 10-2001-0038134

(51) Int. Cl. H01J 29/70; H01J 29/50

(52) U.S. Cl. 313/422; 313/409

(57) ABSTRACT

A side projection type cathode ray tube includes a front panel and at least two electron beam emission units. The front panel has a face portion for displaying an image thereon and a skirt portion backwardly extended from a periphery of the face portion. The electron beam emission units are prepared along the circumference of the skirt portion of the front panel. Each electron beam emission unit has an electron gun for emitting an electron beam and a deflection yoke for deflecting the electron beam emitted from the electron gun. By configuring the cathode ray tube in the above-described manner, the thickness of the cathode ray tube can be greatly reduced.

### TECHNICAL FIELD

The present invention relates to a cathode ray tube; and, more particularly, to a side projection type cathode ray tube capable of emitting electron beams by employing at least two electron beam emission units installed along the circumference of a glass bulb.

### BACKGROUND ART

As well known in the art, a glass bulb of a rear side emission type cathode ray tube for use in a fabrication of a color television, a computer monitor, and the like, includes three main components, i.e., a panel on which an image is displayed, a conic funnel coupled to a rear side of the panel and a tube-shaped neck attached to an end portion of the funnel. The panel has a face portion and a skirt portion. The skirt portion of the panel is formed by backwardly extending a periphery of the face portion. A shadow mask having a plurality of holes is supported at the skirt portion of the panel by stud pins. Respectively installed at an inside and an outside of the neck are an electron gun for emitting an electron beam to a fluorescent material coated on an inner surface of the face portion and a deflection yoke for deflecting the electron beam emitted from the electron gun.

The conventional cathode ray tube configured as described above has a drawback in that it cannot be fully minimized in thickness due to the conic funnel and the neck connected thereto. Further, recent trend for a large-sized cathode ray tube also interferes with a realization of a slim cathode ray tube having a conventional structure. Thus, for the purpose of obtaining a large-sized, slim cathode ray tube, there have been conducted an increasing number of active researches to improve the structure of the conventional cathode ray tube having a single electron gun for emitting an electron beam from a rear side of the panel.

One example of cathode ray tubes having an improved structure is disclosed in Japanese Patent Laid-Open Publication No. 7-45215, in which the cathode ray tube includes two funnels installed at a rear side of a rear package facing a panel, each of the two funnels having a neck. An electron gun and a deflection yoke are installed at each of the two necks. Each of electron beams irradiated from the electron guns is divided into two ranges by corresponding one of the deflection yokes and then illuminated on a fluorescent material prepared on the panel. Further, provided in Korean Patent Laid-Open Publication No. 1999-78385 is another example of cathode ray tubes having an improved structure, in which a plurality of funnels are installed at a rear package that is coupled to a rear side of a face plate. Each of the funnels has a neck connected thereto. Further, each neck includes an electron gun and a deflection yoke. Each of electron beams eradiated from the electron guns is divided by corresponding one of the deflection yokes into a multiplicity of ranges and then illuminated on a fluorescent material coated on a panel. Though the technologies described in Japanese Patent Laid-Open Publication No. 7-45215 and Korean Patent Laid-open Publication No. 1999-78385 have intended to reduce the thickness of the cathode ray tubes by way of employing a plurality of small-sized funnels, there still exists a limit in slimming down the cathode ray tube since those technologies employ a rear side emission system where the electron guns are installed at the rear side of the panel.

In Japanese Patent Laid-Open Publication No. 6-267465, there is disclosed still another example of cathode ray tubes, in which a funnel having a neck on which an electron gun is mounted is located between a screen panel and a front panel. An electron beam from the electron gun is emitted to a fluorescent material coated on the screen panel and an image produced by the fluorescent material is visualized through the front panel. However, this technology is not adequate to be applied to a cathode ray tube of a large size since it is very difficult to control electron beams in a large-sized cathode ray tube and, further, a picture quality is not good.

### DISCLOSURE OF INVENTION

It is, therefore, an object of the present invention to provide a side projection type cathode ray tube whose thickness can be greatly reduced by installing at least two electron beam emission units along the circumference of a glass bulb.

In accordance with the present invention, there is provided a side projection type cathode ray tube including: a front panel having a face portion for displaying an image thereon and a skirt portion backwardly extended from a periphery of the face portion; and at least two electron beam emission units prepared along the circumference of the skirt portion of the front panel, each electron beam emission unit having an electron gun for emitting an electron beam and a deflection yoke for deflecting the electron beam emitted from the electron gun.

### BRIEF DESCRIPTION OF DRAWINGS

The above and other objects and features of the present invention will become apparent from the following description of preferred embodiments given in conjunction with accompanying drawings, in which:

FIG. 1 is a partial cross sectional perspective view of a side projection type cathode ray tube in accordance with a first preferred embodiment of the present invention;

FIG. 2 provides a partial cross sectional front view of the side projection type cathode ray tube in FIG. 1;

FIG. 3 sets forth a cross sectional view of the side projection type cathode ray tube taken along a line X-X of FIG. 2;

FIG. 4 shows a modification of a funnel of the side projection type cathode ray tube in FIG. 1;

FIG. 5 illustrates another modification of the funnel of the side projection cathode ray tube shown in FIG. 1;

FIG. 6 offers a perspective view of a side projection type cathode ray tube in accordance with a second preferred embodiment of the present invention;

FIG. 7 demonstrates a partial cross-sectional front view of the side projection type cathode ray tube in FIG. 6; and

FIG. 8 describes a front view of a modified side projection type cathode ray tube in accordance with the second preferred embodiment of the present invention.

### BEST MODE FOR CARRYING OUT THE INVENTION

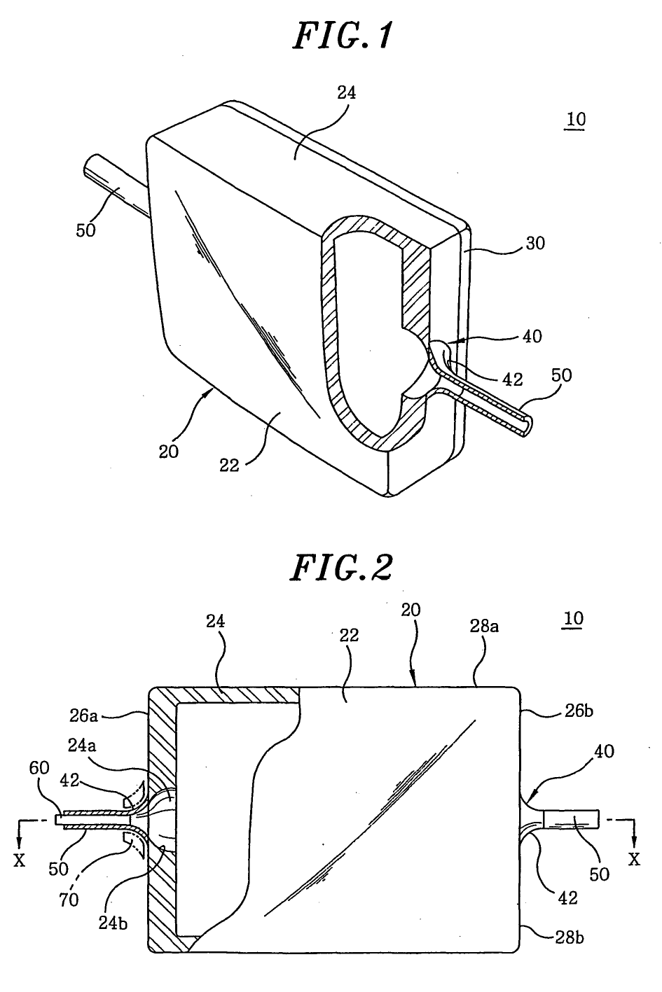

Referring to FIG. 1, there is described a side projection type cathode ray tube in accordance with a first preferred embodiment of the present invention. The side projection type cathode ray tube includes a substantially hexahedral glass bulb 10. The glass bulb 10 includes a front panel 20 and a rear panel 30. The front panel 20 has a face portion 22 on which an image is displayed and a skirt portion 24 backwardly extended from a periphery of the face portion 22. The rear panel 30 is prepared in the back of the skirt portion 24. The face portion 22 of the front panel 20 is of a substantially rectangular plane.

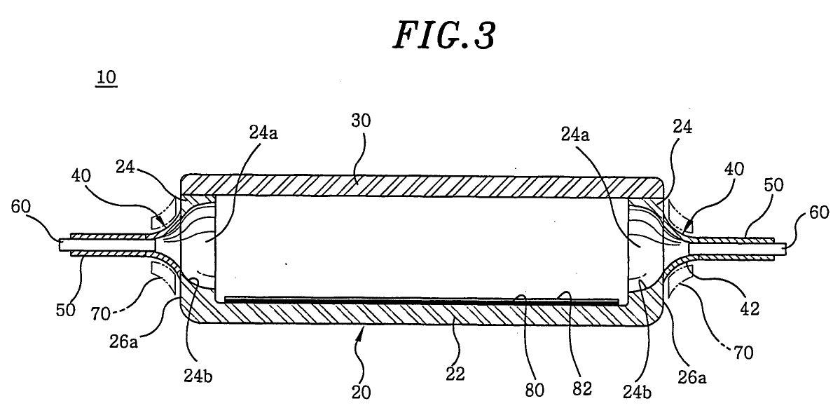

As shown in FIG. 2, the skirt portion 24 of the front panel 20 has a first and a second shorter side 26a and 26b and a first and a second longer side 28a and 28b. Assume that Dm refers to a diagonal length of the face portion 22 and Dt represents a total thickness of the front panel 20 and the rear panel 30, i.e., a thickness of the glass bulb 10. Preferably, a ratio Dt/Dm is set to be 0.35≧Dt/Dm≧0.1.

Two electron beam emission units are prepared in the side projection type cathode ray tube in accordance with the first embodiment of the present invention. Since the two electron beam emission units have identical constitutions, description of only one will be provided hereinbelow for the simplicity.

Referring to FIGS. 1 and 2, the electron beam emission unit includes a funnel 40 installed at the shorter side 26a (or 26b) of the skirt portion 24. The funnel 40 has a yoke portion 42 installed at the shorter side 26a (or 26b) of the skirt portion 24 and a neck 50 connected to the yoke portion 42. Mounted on the neck 50 and the yoke portion 42 are an electron gun 60 and a deflection yoke 70, respectively. To be more specific, the electron gun 60 is installed at an inside of the neck 50 to emit an electron beam onto a desired region on the face portion 22 while the deflection yoke 70 is mounted on the yoke portion 42 in order to deflect the electron beam irradiated from the electron gun 60.

Though two electron beam emission units are respectively installed at center portions of the first and the second shorter side 26a and 26b of the skirt portion 24 in the first preferred embodiment of the present invention, it should be noted that the number of the electron beam emission units can vary depending on the size of the glass bulb 10.

As illustrated in FIG. 3, the front panel 20, the rear panel 30, the yoke portions 42, and the necks 50 of the glass bulb 10 are assembled by using crystalline powder glass such as frit or by employing a thermal bonding technique. Since the use of the crystalline powder glass and the thermal bonding technique in fabricating the glass bulb 10 is well known in the art, descriptions thereof will be omitted.

On an inner surface of the face portion 22 of the front panel 20, there is coated a fluorescent material 80 for an image formation. Further, prepared at the skirt portion 24 is a shadow mask 82 having a plurality of holes (not shown). The electron beams emitted from the electron guns 60 are deflected by the deflection yokes 70 toward the front panel 20 or the rear panel 30, as will be described later in detail, and eradiated through the holes in the shadow mask 82 to the fluorescent material 80, thereby displaying an image thereon.

In the meantime, the side projection type cathode ray tube of the present invention can be implemented as a beam index tube type one by employing an index stripe and a photo detector in lieu of the shadow mask 82. An explanation of such technology will not be presented herein since it is well known in the relevant art. In the case of using the index stripe and the photo detector instead of the shadow mask, the electron beams emitted from the electron guns can be more effectively controlled and, further, a screen can be divided into a plurality of separate regions by installing electron beam emission units at several locations along the circumference of the glass bulb 10.

Referring to FIG. 2 and FIG. 3, a pair of holes 24a are formed at the skirt portion 24 of the front panel 20 to communicate with the funnels 40. Each hole 24a has a curved portion 24b at an inner surface thereof in order to allow the electron beams emitted from the electron guns 60 and subsequently deflected by the deflection yokes 70 to be accepted into the glass bulb 10.

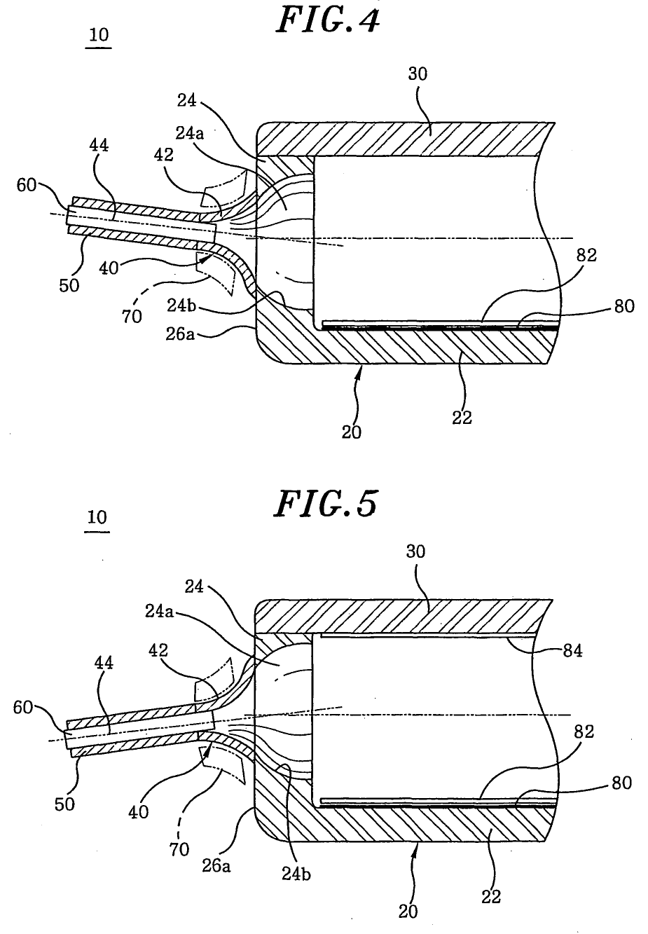

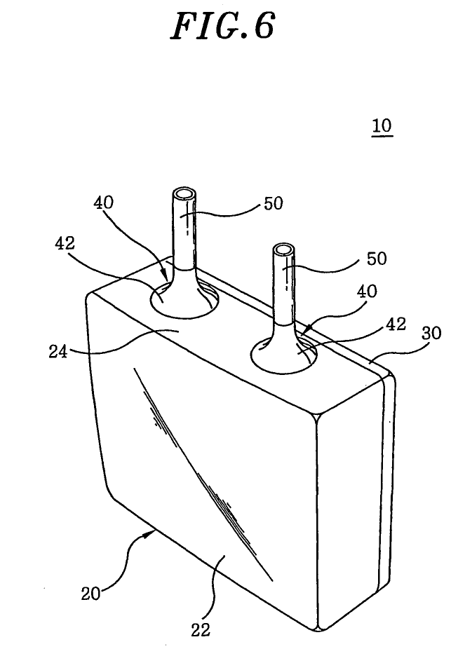

FIG. 4 exemplifies a modification of the funnel 40 of the side projection type cathode ray tube in accordance with the first preferred embodiment of the present invention. A modified funnel 40 is installed in such a manner that a central axis 44 thereof inclines toward the face portion 22 of the front panel 20. Accordingly, electron beams emitted from the electron gun 60 are deflected to the fluorescent material 80 coated on the face portion 22 via the deflection yoke 70. FIG. 5 shows another modified funnel 40, in which the central axis 44 of the funnel 40 inclines toward the rear panel 30. In this case, a reflective material 84 is coated on an inner surface of the rear panel 30 in order to reflect electron beams coming from the electron gun 60 toward the fluorescent material 80 plated on the face portion 22 of the front panel 20. Accordingly, electron beams from the electron gun 60 are deflected toward the reflective material 84 via the deflection yoke 70 and, then, reflected to the fluorescent material 80 by the reflective material 84. It is preferable to form the rear panel 30 and/or the reflective material 84 to have a spherical surface in order to improve a reflection efficiency of the electron beams.

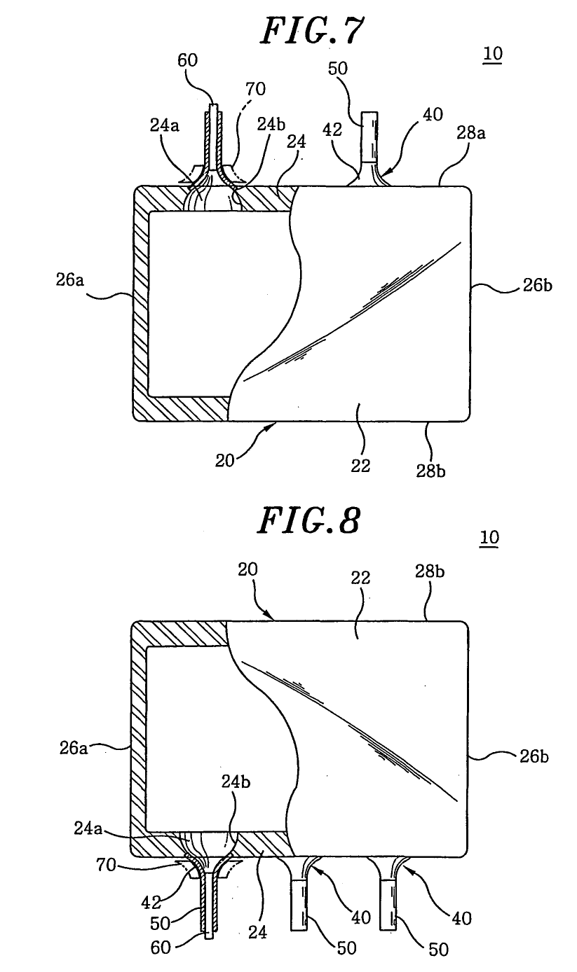

FIGS. 6 and 7 describe a side projection type cathode ray tube in accordance with a second preferred embodiment of the present invention. The cathode ray tube in the second embodiment has a same configuration as the one in the first embodiment except for locations of funnels 40. For instance, two funnels 40 are located at a left and a right side of a center portion of the first longer side 28a of the face portion 22, respectively, unlike in the first embodiment where two funnels are positioned opposite to each other at the first and the second shorter side 26a and 26b, respectively. Herein, the number and locations of the funnels can be changed in various ways. For example, FIG. 8 shows three funnels 40 located at the second longer side 28b of the face portion 22.

Though the above descriptions illustrate two or three funnels 40 placed at the first longer side 28a or the second longer side 28b of the face portion 22, the number and locations of the funnels can be changed if required, as mentioned above. That is to say, at least one funnel can be located at one side of the skirt portion or at two opposite sides thereof. For example, if two funnels are provided, one may be positioned at a longer side of the skirt portion while the other is placed at a shorter side thereof.

As described above, by installing at least two funnels, on which the electron beam emission units are mounted, along the circumference of the glass bulb, the thickness of the side projection type cathode ray tube can be greatly reduced.

While the invention has been shown and described with respect to the preferred embodiments, it will be understood by those skilled in the art that various changes and modifications may be made without departing from the spirit and scope, of the invention as defined in the following claims.

1. A side projection type cathode ray tube comprising:
a front panel including a face portion for displaying an image thereon and a skirt portion backwardly extended from a periphery of the face portion; and
at least two electron beam emission units prepared along the circumference of the skirt portion of the front panel, each electron beam emission unit having an electron gun for emitting an electron beam and a deflection yoke for deflecting the electron beam emitted from the electron gun.

2. The cathode ray tube of claim 1, wherein the face portion has a cross-section of a substantially rectangular shape with a pair of shorter sides and a pair of longer sides and said at least two electron beam emission units are placed opposite to each other at the pair of shorter sides of the face portion, respectively.

3. The cathode ray tube of claim 1, wherein the face portion has a cross-section of a substantially rectangular shape with a pair of shorter sides and a pair of longer sides and said at least two electron beam emission units are placed at either one of the pair of longer sides of the face portion.

4. The cathode ray tube of any one of claims 1 to 3, wherein said at least two electron beam emission units are installed in such a manner that central axes thereof incline toward the face portion of the front panel.

5. The cathode ray tube of any one of claims 1 to 3, further comprising a rear panel facing the face portion of the front panel and said at least two electron beam emission units are installed in such a manner that central axes thereof incline toward the rear panel.

6. The cathode ray tube of claim 1, wherein at least two holes are formed on the skirt portion of the front panel to communicate with said at least two electron beam emission units and each of the holes has a curved surface portion for accepting deflected electron beams coming from the electron guns via the corresponding deflection yokes.

7. The cathode ray tube of claim 1, further comprising a rear panel facing the face portion of the front panel and a ratio Dt/Dm is set to be 0.35≧Dt/Dm≧0.1, wherein Dm represents a diagonal length of the face portion and Dt refers to a total combined thickness of the front panel and the rear panel.

8. The cathode ray tube of claim 5, wherein the face portion of the front panel is coated with a fluorescent material for displaying thereon an image by using electron beams emitted from the electron guns and the rear panel is plated with a reflective material for reflecting the electron beams from the electron guns toward the fluorescent material on the face portion of the front panel.

9. The cathode ray tube of claim 8, wherein the rear panel and/or the reflective material are of a spherical shape.
